(19) United States
(12) Patent Application Publication
(10) Pub. No.: US 2007/0268100 A1
(43) Pub. Date: Nov. 22, 2007

(54) Electrical switching apparatus, and movable contact assembly and shield therefor

(75) Inventors: Brian J. Schaltenbrand, Cranberry Township, PA (US); Robert W. Mueller, Green Township, PA (US); Mark A. Janusek, Pittsburgh, PA (US); John J. Kurtz, Pittsburgh, PA (US); Gino C. Iorfida, Oakdale, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/436,336

(22) Filed: May 18, 2006

(51) Int. Cl. H01H 9/30

(52) U.S. Cl. 335/201

(57) ABSTRACT

A shield is provided for a circuit breaker including a housing, a movable contact, a stationary contact, and an operating mechanism for moving the movable contact into and out of electrical contact with the stationary contact. The operating mechanism includes a crossbar, a biasing member, and a movable contact assembly. The movable contact assembly has a movable contact arm pivotably coupled to the crossbar, and includes a first end carrying the movable contact, and a second end biased by the biasing member, thereby biasing the movable contact toward the stationary contact. The shield comprises an elongated barrier element having an opening which receives the movable contact arm. The elongated barrier element is coupled to the operating mechanism crossbar proximate the second end of the movable contact arm in order to shield at least the biasing member. A movable contact assembly, and electrical switching apparatus are also provided.

### BACKGROUND OF THE INVENTION

1. Field of the Invention

The invention relates generally to electrical switching apparatus and, more particularly, to an electrical switching apparatus having a movable contact assembly with a shield. The invention also relates to movable contact assemblies for electrical switching apparatus, and to shields for the movable contact assemblies of electrical switching apparatus.

2. Background Information

Electrical switching apparatus, such as circuit breakers, provide protection for electrical systems from electrical fault conditions such as, for example, current overloads, short circuits, and other fault conditions. Typically, circuit breakers include a spring powered operating mechanism which opens electrical contacts to interrupt the current through conductors of an electrical system in response to abnormal conditions.

The electrical contacts generally comprise one or more movable contacts and one or more corresponding stationary contacts. Each movable contact is disposed at or about a first end of a spring-biased movable contact arm. The spring-biased movable contact arm is pivotably coupled, at or about its second end, to a crossbar of the operating mechanism. The crossbar carries the movable contact arms for all of the poles of the circuit breaker, and allows for simultaneous opening and closing of the contacts in all of the poles. The operating mechanism controls the spring-biased movable contact arm to pivot the movable contact into and out of electrically conductive engagement with the corresponding stationary contact. A contact arm spring biases the second end of the movable contact arm, proximate the crossbar of the operating mechanism, in order to maintain the closed position of the pair of movable and stationary contacts.

During a trip condition, such as, for example, interruption of a short circuit, an arcing event occurs when the movable contact initially separates from the corresponding stationary contact. Debris such as, for example, molten material (e.g., molten metal), can be formed as a byproduct of the arcing event. Such debris can be blown backward towards the crossbar and can attach to the contact arm spring causing the coils of the spring to become welded together. This undesirable condition may adversely affect the operation of the movable contact arm, and the current interruption function of the circuit breaker, in general. For example, a welded contact arm spring can prevent blow-off of the movable contact from the corresponding stationary contact, and/or it can reduce contact pressure between the movable contact and the corresponding stationary contact.

There is, therefore, room for improvement electrical switching apparatus, such as circuit breakers, and in movable contact assemblies therefor.

### SUMMARY OF THE INVENTION

These needs and others are met by embodiments of the invention, which are directed to a movable contact assembly for an electrical switching apparatus, such as a circuit breaker having a spring-biased movable contact arm. A shield for the movable contact assembly protects at least the spring of the spring-biased movable contact arm from harmful arcing event byproducts, without adversely affecting the operability of the movable contact arm, or the overall current interruption performance of the circuit breaker.

As one aspect of the invention, a shield is provided for an electrical switching apparatus. The electrical switching apparatus includes a housing, a movable contact, a stationary contact, and an operating mechanism for moving the movable contact into and out of electrical contact with the stationary contact. The operating mechanism includes a crossbar, a biasing member, and a movable contact assembly. The movable contact assembly has a movable contact arm pivotably coupled to the crossbar. The movable contact arm has a first end and a second end, with the movable contact being disposed at or about the first end of the movable contact arm, and the biasing member being structured to bias the second end of the movable contact arm, thereby biasing the movable contact disposed at or about the first end of the movable contact arm toward the stationary contact. The shield comprises: an elongated barrier element including a first end, a second end, and an opening disposed between the first end and the second end, wherein the elongated barrier element is structured to be coupled to the crossbar of the operating mechanism of the electrical switching apparatus proximate the second end of the movable contact arm in order to shield at least the biasing member of the movable contact assembly.

The elongated barrier element may be structured to receive the movable contact arm of the movable contact assembly. A portion of the elongated barrier element proximate the opening of the elongated barrier element may be structured to engage the crossbar of the operating mechanism of the electrical switching apparatus. The first end of the elongated barrier element may also be structured to be coupled to the crossbar. The elongated barrier element may include at least two bends. The bends may comprise a first bend at or about the first end of the elongated barrier element, and a second bend at or about the opening of the elongated barrier element, wherein the bends are structured to permit the elongated barrier element to generally conform to the crossbar. The elongated barrier element may be made from an electrically insulative and heat-resistant material, and it may comprise one single piece.

As another aspect of the invention, a movable contact assembly is provided for an electrical switching apparatus including a housing, a movable contact, a stationary contact, and an operating mechanism including a crossbar. The operating mechanism is structured to move the movable contact into and out of electrical contact with the stationary contact. The movable contact assembly comprises: a movable contact arm including a first end and a second end, the second end of the movable contact arm being structured to be pivotably coupled to the crossbar of the operating mechanism of the electrical switching apparatus, the movable contact of the electrical switching apparatus being disposed at or about the first end of the movable contact arm; a biasing member biasing the second end of the movable contact arm, thereby biasing the movable contact disposed at or about the first end of the movable contact arm toward the stationary contact; and a shield comprising: an elongated barrier element having a first end structured to be coupled to the crossbar of the operating mechanism of the electrical switching apparatus, a second end, and an opening disposed between the first end and the second end, wherein the opening of the elongated barrier element receives the movable contact arm, and wherein the elongated barrier element is structured to shield at least the biasing member of the moving contact assembly from an arc when the movable contact separates from the stationary contact.

The crossbar of the operating mechanism may include a protrusion wherein the first end of the elongated barrier element comprises an aperture structured to engage the protrusion. The biasing member may be a spring having a first end and a second end wherein the first end of the spring biases the second end of the movable contact arm of the movable contact arm assembly, and the second end of the spring engages and secures the first end of the elongated barrier element about the protrusion of the crossbar of the operating mechanism of the electrical switching apparatus.

As another aspect of the invention, an electrical switching apparatus comprises: a housing; separable contacts housed by the housing, the separable contacts comprising at least one movable contact and at least one stationary contact; an operating mechanism including a crossbar, the operating mechanism being structured to move the at least one movable contact into and out of electrical contact with a corresponding one of the at least one stationary contact; and at least one movable contact assembly comprising: a movable contact arm including a first end and a second end, the at least one movable contact being disposed at or about the first end of the movable contact arm, the second end of the movable contact arm being pivotably coupled to the crossbar of the operating mechanism, a biasing member biasing the second end of the movable contact arm, thereby biasing the at least one movable contact disposed at or about the first end of the movable contact arm toward the corresponding one of the at least one stationary contact, and a shield comprising: an elongated barrier element coupled to the crossbar of the operating mechanism of the electrical switching apparatus, wherein the elongated barrier element is structured to shield at least the biasing member of the movable contact assembly from an arc when the at least one movable contact separates from the corresponding one of the at least one stationary contact.

### BRIEF DESCRIPTION OF THE DRAWINGS

A full understanding of the invention can be gained from the following description of the preferred embodiments when read in conjunction with the accompanying drawings in which:

FIG. 1 is a side, cross-sectional view of a circuit breaker, and a movable contact assembly and shield therefor, in accordance with an embodiment of the invention;

FIG. 2 is an isometric view of the shield of FIG. 1 prior to the shield being installed in the circuit breaker;

FIG. 3 is an isometric view of the front of the circuit breaker crossbar of FIG. 1, showing one movable contact assembly and shield therefor coupled to the crossbar; and

FIG. 4 is an isometric view of the back of the circuit breaker crossbar, movable contact assembly and shield of FIG. 3.

### DESCRIPTION OF THE PREFERRED EMBODIMENTS

For purposes of illustration, embodiments of the invention will be described as applied to a shield for the spring of a spring-biased movable contact assembly for a circuit breaker, although it will become apparent that they could also be applied to shield and protect a wide variety of components of any known or suitable electrical switching apparatus (e.g., without limitation, circuit switching devices and circuit interrupters such as circuit breakers, contactors, motor starters, motor controllers and other load controllers).

Directional phrases used herein, such as, for example, left, right, front, back, clockwise, counterclockwise and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

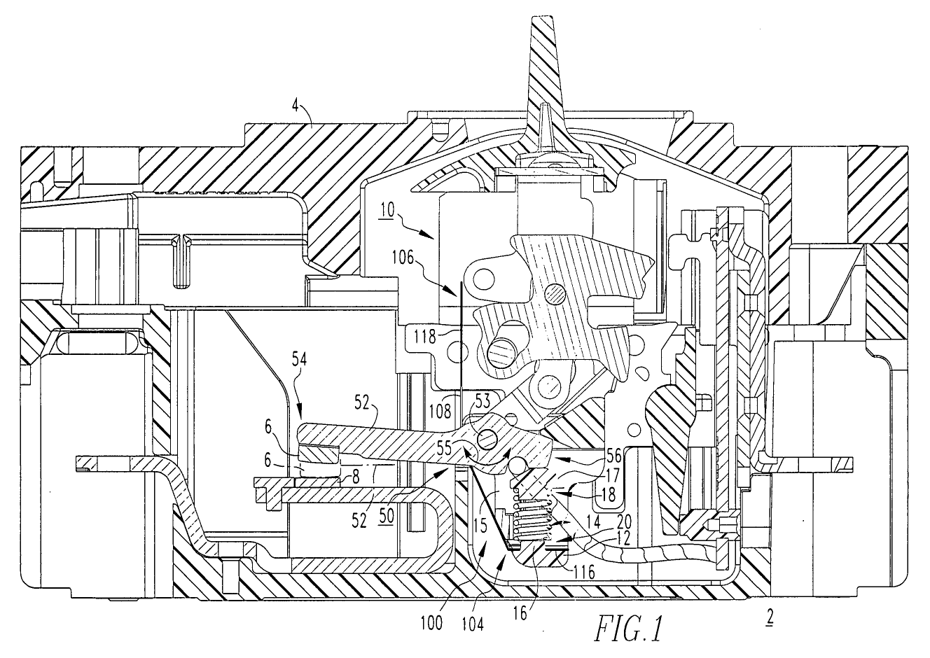

FIG. 1 shows a circuit breaker 2 having a movable contact assembly 50 with a shield 100. The circuit breaker 2 generally includes a housing 4, separable contacts 6, 8 housed by the housing 4, and an operating mechanism 10. The operating mechanism 10 includes at least one movable contact assembly 50. For simplicity of illustration, one movable contact assembly 50, and one pair of separable contacts 6, 8 therefor, will be shown and described herein. It will, however, be appreciated that any known or suitable number of movable contact assemblies 50 could be employed. For example, typically for a multi-pole molded case circuit breaker 2 such as the one shown in FIG. 1, one movable contact assembly 50 is employed for each pole of the circuit breaker 2.

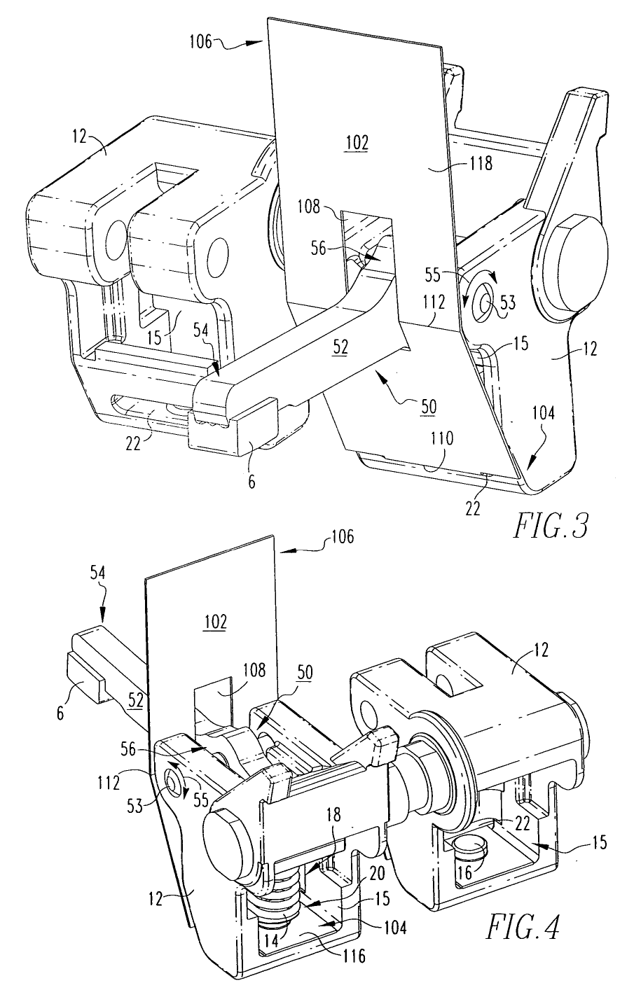

Continuing to refer to FIG. 1, and also to FIGS. 3 and 4, it will be appreciated that the separable contacts comprise a movable contact 6, and a stationary contact 8. The operating mechanism 10 may be substantially similar to that which is shown and described in U.S. Pat. No. 5,910,760 issued Jun. 8, 1999 to Malingowski et al., entitled “Circuit Breaker with Double Rate Spring.” As shown in FIG. 1, the operating mechanism 10 includes a crossbar 12. The operating mechanism 10 and crossbar 12 are structured to move the moveable contact 6 into and out of electrical contact with the stationary contact 8. The movable contact assembly 50 includes a movable contact arm 52 having a first end 54 and a second end 56. The movable contact 6 is disposed at or about the first end 54 of the movable contact arm 52, as shown. The second end 56 of the movable contact arm 52 is pivotably coupled to the crossbar 12 of operating mechanism 10 by a pivot 53. A biasing member, such as the spring 14 shown in FIGS. 1 and 4, biases the second end 56 of the movable contact arm 52, by way of a cam follower 17 as described and shown in the aforementioned U.S. Pat. No. 5,910,760. This, in turn, biases the movable contact 6 disposed at or about the first end 54 of the movable contact arm 52 toward the stationary contact 8 (FIG. 1). In this manner, the operating mechanism 10 and crossbar 12 thereof, cooperate with the movable contact assembly 50 in order to pivot the movable contact arm 52 about pivot 53 in the directions indicated by arrow 55, and thereby open (clockwise with respect to FIGS. 1, 3, and 4) and close (counterclockwise with respect to FIGS. 1, 3 and 4) separable contacts 6, 8. In other words, the movable contact arm 52 pivots clockwise and counterclockwise (with respect to FIG. 1) to bring the separable contacts 6, 8 into (as shown in phantom line drawing) and out of (as shown) electrical communication with one another. In the example of FIG. 1, the operating mechanism 10, crossbar 12 and movable contact assembly 50 are shown in the tripped position, with the movable contact 6 and stationary contact 8 being separated.

The shield 100 of the movable contact assembly 50 generally comprises an elongated barrier element 102 coupled to the crossbar 12 of operating mechanism 10. The elongated barrier element 102 is structured to shield at least the spring 14 (FIGS. 1 and 4) of the movable contact assembly 50 from an arc when the movable contact 6 separates from the stationary contact 8 (FIG. 1). Specifically, as previously discussed, an arc can generate flames and debris which can be harmful to circuit breaker components, such as the spring 14. More specifically, molten metal debris which can be blown into the spring 14 as the result of an arcing event, can weld the coils of the spring 14 together, thereby inhibiting the circuit interrupting performance (e.g., without limitation, preventing blow-off, reducing contact pressure) of the circuit breaker 2. To resist such circumstances, the shield 100 provides a barrier element 102 disposed between the spring 14 and the separable contacts 6, 8 where the arc originates.

More specifically, the elongated barrier element 102 of shield 100 includes a first end 104, a second end 106, and an opening 108 disposed between the first and second ends 104, 106. The opening 108 of the elongated barrier element 102 is structured to receive the movable contact arm 52 of movable contact assembly 50, as best shown in FIG. 3. The first end 104 of the elongated barrier element 102 is structured to be coupled to crossbar 12 of operating mechanism 10, and a portion of elongated barrier element 102 proximate the opening 108 therein is structured to engage crossbar 12 of the operating mechanism 10, as shown in FIGS. 1, 3 and 4.

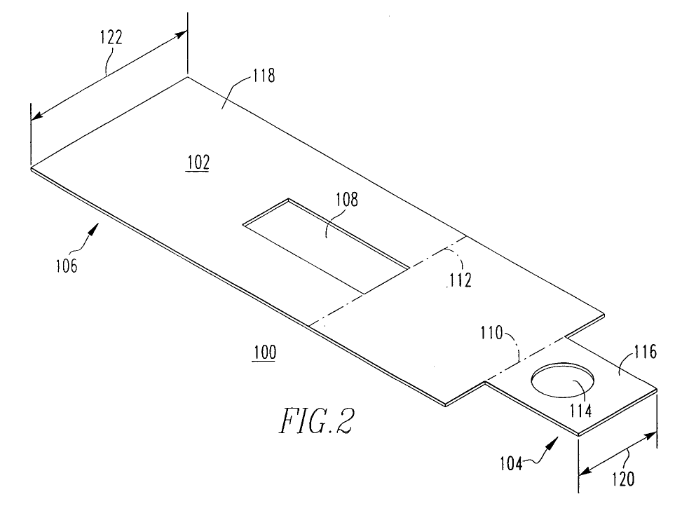

The crossbar 12 of operating mechanism 10 comprises a molded member 12 which defines a cavity 15, including a protrusion 16 (FIGS. 1 and 4) disposed within the cavity 15. The second end 56 of the movable contact arm 52 extends into the cavity 15, as best shown in FIG. 4. The first end 104 of the elongated barrier element 102 of shield 100 also extends into the cavity 15. Specifically, the first end 104 comprises an aperture 114 (best shown in FIG. 2) which engages the protrusion 16 within the cavity 15 of crossbar 12. The first end 104 of elongated barrier element 102 is then held in place by spring 14, which is also disposed within the cavity 15 of crossbar 12. More specifically, as shown in FIGS. 1 and 4, the spring 14 has a first end 18 and a second end 20. The first end 18 engages and biases the cam follower 17 which in turn biases the second end 56 of movable contact arm 52, as previously discussed, and the second end 20 engages and secures the first end 104 of the elongated barrier element 102 about the protrusion 16 of crossbar 12, as shown. The crossbar 12 further comprises a slot 22 (best shown in FIG. 3) for providing access into the cavity 15. As will now be discussed, the first end 104 of the elongated barrier element 102 is inserted through the slot 22.

As shown in FIG. 2, the elongated barrier element 102 of shield 100 further comprises a first portion having a first width 120, and a second portion 118 having a second width 122. The second width 122 of second portion 118 is greater than the first width 120 of first portion 116. This configuration permits the first portion 116 of the first end 104 of the elongated barrier element 102 to be inserted through the slot 22 of crossbar 12, and into cavity 15 thereof, as shown in FIGS. 3 and 4. When installing the shield 100, once the first portion 116 has been inserted and secured about protrusion 16 by the second end 20 of spring 14, the second portion 118 of the shield 100 is bent upward in order to generally conform to the crossbar 12. More specifically, the elongated barrier element 102 of shield 100 includes at least two bends, a first bend 110 between the first portion 16 of the elongated barrier 102 and the second portion 118 of the elongated barrier 102, and a second bend 112 at or about the opening 108 of the elongated barrier. In FIG. 2, the elongated barrier element 102 is shown prior to being coupled to the crossbar 12 (FIGS. 1, 3 and 4), and thus before first and second bends 110, 112 have been bent in order for the shield 100 to generally conform to the crossbar 12 (FIGS. 1, 3 and 4).

The movable contact arm 52 of movable contact assembly 50 is received through the opening 108 of the elongated barrier element 102 regardless of whether the movable contact 6 separates from or is in electrical contact with the corresponding stationary contact 8 (FIG. 1). Accordingly, the shield 100 provides an effective barrier which shields and protects the spring 14 of the movable contact arm assembly 50, without inhibiting the operation of the movable contact arm 52. The elongated barrier element 102 of the exemplary shield 100 comprises one single piece of electrically insulative and heat-resistant (i.e., flame retardant) material. For example, and without limitation, the elongated barrier element 102 can be made from fishpaper, flame-resistant fiber, Teflon® coated glass material, or any other known or suitable material which can withstand the arc and its byproducts (e.g., molten metal debris). It will also be appreciated that the shield 100 could alternatively be made from more than one piece of suitable material, without departing from the scope of the invention.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1-13. (canceled)

14. An electrical switching apparatus comprising:
a housing;
separable contacts housed by said housing, said separable contacts comprising at least one movable contact and at least one stationary contact;
an operating mechanism including a crossbar, said operating mechanism being structured to move said at least one movable contact into and out of electrical contact with a corresponding one of said at least one stationary contact; and
at least one movable contact assembly comprising:
a movable contact arm including a first end and a second end, said at least one movable contact being disposed at or about the first end of said movable contact arm, the second end of said movable contact arm being pivotably coupled to said crossbar of said operating mechanism,
a biasing member biasing the second end of said movable contact arm, thereby biasing said at least one movable contact disposed at or about the first end of said movable contact arm toward said corresponding one of said at least one stationary contact, and
a shield comprising:
an elongated barrier element coupled to said crossbar of said operating mechanism of said electrical switching apparatus,
wherein said elongated barrier element is structured to shield at least said biasing member of said movable contact assembly from an arc when said at least one movable contact separates from said corresponding one of said at least one stationary contact,
wherein said elongated barrier element comprises a first end, a second end, and an opening disposed between the first end of said elongated barrier element and the second end of said elongated barrier element, and
wherein said elongated barrier element is substantially flat between the first end of said elongated barrier element and the opening of said elongated barrier element.

15. The electrical switching apparatus of claim 14 wherein the opening of said elongated barrier element receives said movable contact arm of said movable contact assembly regardless of whether said at least one movable contact separates from or is in electrical contact with said corresponding one of said at least one stationary contact.

16. The electrical switching apparatus of claim 15 wherein a portion of said elongated barrier element proximate the opening of said elongated barrier element is disposed proximate said crossbar of said operating mechanism.

17. The electrical switching apparatus of claim 15 wherein said crossbar of said operating mechanism comprises a molded member; wherein said molded member defines a cavity including a protrusion disposed within said cavity; wherein the second end of said movable contact arm of said movable contact assembly extends into said cavity of said molded member; and wherein the first end of said elongated barrier element comprises an aperture which engages said protrusion within said cavity of said molded member.

18. The electrical switching apparatus of claim 17 wherein said biasing member is a spring having a first end and a second end; wherein said operating mechanism further comprises a cam follower disposed in said cavity between the first end of said spring and the second end of said movable contact arm; wherein said spring is disposed within said cavity of said molded member; wherein the first end of said spring biases said cam follower and the second end of said movable contact arm of said movable contact assembly; and wherein the second end of said spring engages and secures the first end of said elongated barrier element about said protrusion within said cavity of said molded member.

19. The electrical switching apparatus of claim 17 wherein said molded member further comprises a slot structured to provide access into said cavity; wherein the first end of said elongated barrier element further comprises a first portion; and wherein said first portion is inserted through said slot of said molded member into said cavity of said molded member.

20. The electrical switching apparatus of claim 19 wherein said elongated barrier element further comprises a second portion; wherein said first portion of said elongated barrier element has a first width; wherein said second portion of said elongated barrier element has a second width; wherein the second width of said second portion of said elongated barrier element is greater than the first width of said first portion of said elongated barrier element; wherein said elongated barrier element includes at least two bends in order that said elongated barrier element generally conforms to said crossbar of said operating mechanism; and wherein said at least two bends comprise a first bend between said first portion of said elongated barrier element and said second portion of said elongated barrier element, and a second bend at or about the opening of said elongated barrier element.
